(19) United States
(12) Patent Application Publication
(10) Pub. No.: US 2007/0218317 A1
(43) Pub. Date: Sep. 20, 2007

(54) Vertical magnetic recording medium

(75) Inventors: Ryo Kurita, Kawasaki (JP); Toshio Sugimoto, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/523,677

(22) Filed: Sep. 19, 2006

(30) Foreign Application Priority Data
Mar. 20, 2006 (JP) 2006-076125

(51) Int. Cl. G11B 5/66

(52) U.S. Cl. 428/828.1; 360/131

(57) ABSTRACT

The vertical magnetic recording medium includes a first recording layer 16 having an easy magnetization axis directed vertical to a surface of the substrate 10, a second recording layer 20 formed over the first recording layer 16 and having an easy magnetization axis directed in-plane of the substrate 10 or oblique to the surface of the substrate 10, and a third recording layer 24 formed over the second recording layer 20 and having an easy magnetization axis directed vertical to the surface of the substrate 10, whereby the vertical magnetization recording medium can improve the reproduction output and can prevent the degradation of the signal quality due to the reproduction output decrease.

### CROSS-REFERENCE TO RELATED APPLICATIONS

This application is based upon and claims the benefit of priority from the prior Japanese Patent Application No. 2006-076125, filed on Mar. 20, 2006, the entire contents of which are incorporated herein by reference.

### BACKGROUND OF THE INVENTION

The present invention relates to a magnetic recording medium, more specifically, a vertical magnetic recording medium used in vertical magnetic recording.

Hard disc devices, which are magnetic recording devices, are widely used outside memory devices of computers and various portable information terminals, e.g., mobile personal computers, game systems, digital cameras, car navigation systems, etc.

As a recording medium, which is used in such the hard disc devices, recently a vertical magnetic recording medium, whose coercive force is double that of the conventional in-plane recording medium, is noted. The vertical magnetic recording is a magnetic recording mode of having magnetic domains formed so that adjacent recording bits are anti-parallel with each other vertically to the plane of the recording medium.

The so-called “thermal fluctuation”, i.e., when recording is made in high density, the magnetic domains are decreased, and the recorded information is lost, is noted in the magnetic recording medium for the vertical magnetic recording. As a means for suppressing the thermal fluctuation, the use of a material of high magnetic anisotropic energy Ku is effective. On the other hand, the increase of the magnetic anisotropic energy increases the recording magnetic field. The effectiveness is limited. Then, it is a problem to make the suppressed thermal fluctuation and the ensured sufficient saturated recording characteristics compatible with each other.

As a countermeasure to this, the recording layer of a multilayer structure of two or more layers is proposed. This countermeasure is for improving the recording characteristics by laying recording layers which are different in the magnetic anisotropy. However, it is complicated and difficult to control compositions and structures of the respective layers for obtaining required magnetic characteristics. Furthermore, generally, the film thickness tends to be very thick, and it is a problem that the recording magnetic fields from the head are not sufficient.

In such background, a vertical magnetic recording medium including a recording layer of two magnetic layers which are different in the magnetization direction is proposed. Such vertical magnetic recording medium, which is called ECC (Exchange Coupled Composite) medium, includes two magnetic films respectively having the easy magnetization axis vertical and in-plane to the substrate or having the easy magnetization axes oblique to each other, whereby the recording magnetic field is decreased while the thermal stability being ensured, and the side erase can be suppressed.

The related arts are disclosed in, e.g., Reference 1 (Japanese published unexamined patent application No. S62-239314 ) and Reference 2 (Japanese published. unexamined patent application No. 2002-203306).

However, in the conventional ECC medium described above, because of the easy magnetization axis of the recording layer being oblique to the substrate normal, the signal output loss is so large that the S/N ratio cannot be sufficient. Often, the magnetization component parallel to the substrate becomes a noise source and reduces the signal quality. A vertical magnetic recording medium which can improve the reproduction output and the S/N ratio has been expected.

### SUMMARY OF THE INVENTION

An object of the present invention is to provide a magnetic recording medium of the vertical magnetic recording mode which can improve the reproduction output and the S/N ratio.

According to one aspect of the present invention, there is provided a vertical magnetic recording medium comprising: a first recording layer formed over a substrate and having an easy magnetization axis directed vertical to a surface of the substrate; a second recording layer formed over the first recording layer and having an easy magnetization axis directed in-plane of the substrate or oblique to the surface of the substrate; and a third recording layer formed over the second recording layer and having an easy magnetization axis directed vertical to the surface of the substrate.

According to another aspect of the present invention, there is provided a magnetic recording device comprising: a vertical magnetic recording medium including a first recording layer formed over a substrate and having an easy magnetization axis directed vertical to a surface of the substrate, a second recording layer formed over the first recording layer and having an easy magnetization axis directed in-plane of the substrate or oblique to the surface of the substrate, and a third recording layer formed over the second recording layer and having an easy magnetization axis directed vertical to the surface of the substrate; and a magnetic head disposed near the vertical magnetic recording medium, for recording magnetic information in a prescribed recording region of the vertical magnetic recording medium and reading magnetic information in a prescribed recording region of the vertical magnetic recording medium.

According to the present invention, the vertical magnetic recording medium comprises a first recording layer formed over a substrate and having an easy magnetization axis directed vertical to a surface of the substrate, a second recording layer formed over the first recording layer and having an easy magnetization axis directed in-plane of the substrate or oblique to the surface of the substrate, and a third recording layer formed over the second recording layer and having an easy magnetization axis directed vertical to the surface of the substrate, whereby the magnetization direction of the upper part of the medium can approach the normal direction of the substrate. Accordingly, the reproduction output of the vertical magnetic recording medium can be improved, and prevent the degradation of the signal quality due to the reproduction output decrease. The magnetic recording device comprising such vertical magnetic recording medium can have the characteristics and reliability improved.

### BRIEF DESCRIPTION OF THE DRAWINGS

FIG. 1 is a diagrammatic sectional view of the vertical magnetic recording medium according to a first embodiment of the present invention, which shows a structure thereof.

FIGS. 2A and 2B are views showing the magnetization directions of the respective recording layers of the vertical magnetic recording medium according to the first embodiment of the present invention.

FIGS. 3 and 4 are graphs showing the relationship between the signal output from the vertical magnetic recording medium and film thickness of the exchange-coupling force control layer.

FIG. 5 is a graph showing the relationship between the signal quality of the signal output from the vertical magnetic recording medium and film thickness of the exchange coupling force control layer.

FIGS. 6 and 7 are graphs of MH loop characteristics of the third recording layer of the vertical magnetic recording medium according to the first embodiment of the present invention.

FIGS. 8 and 9 are diagrammatic sectional views of the modifications of the vertical magnetic recording medium according to the first embodiment of the present invention, which show a structure thereof.

FIG. 10 is a diagrammatic view of the magnetic recording device according to a second embodiment of the present invention, which shows a structure thereof.

### DETAILED DESCRIPTION OF THE PREFERRED EMBODIMENTS

### A First Embodiment

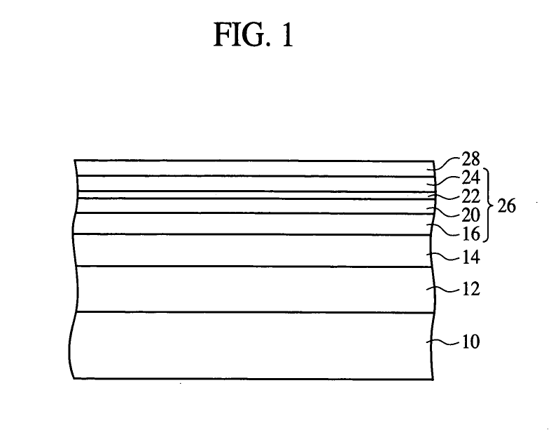

The vertical magnetic recording medium according to a first embodiment of the present invention will be explained with reference to FIGS. 1 to 9.

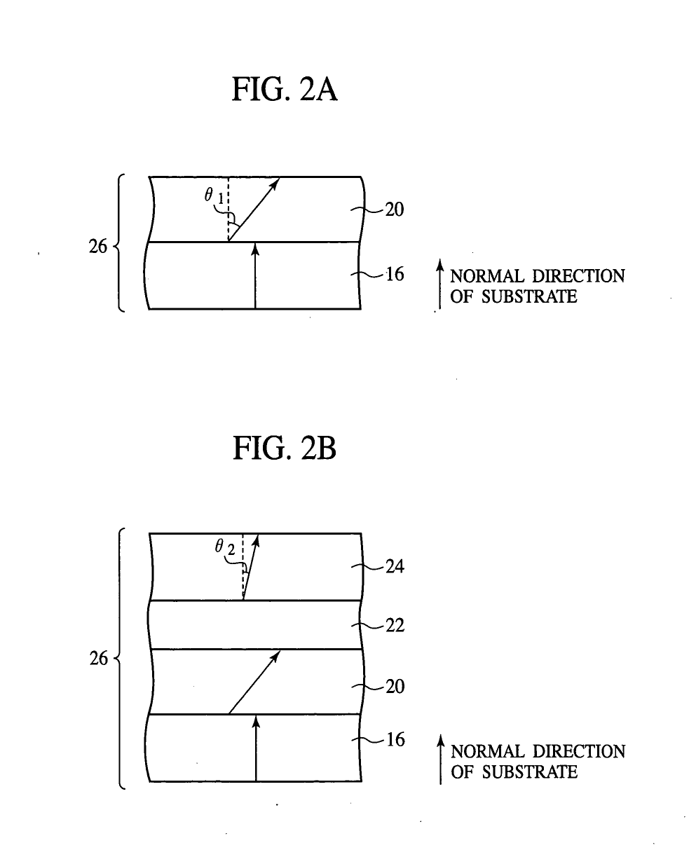

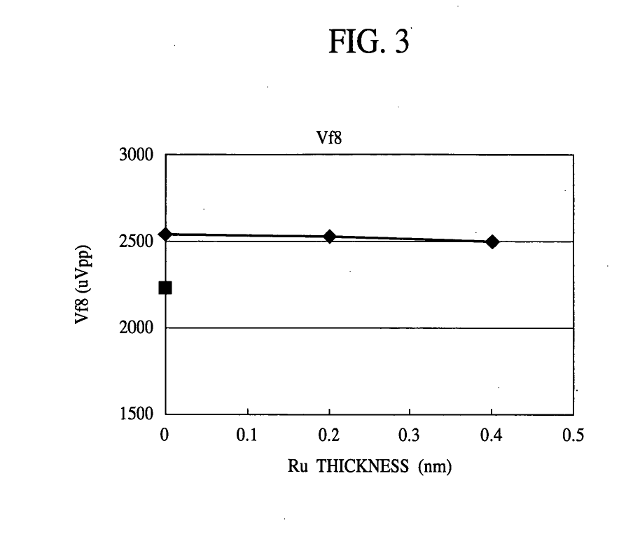

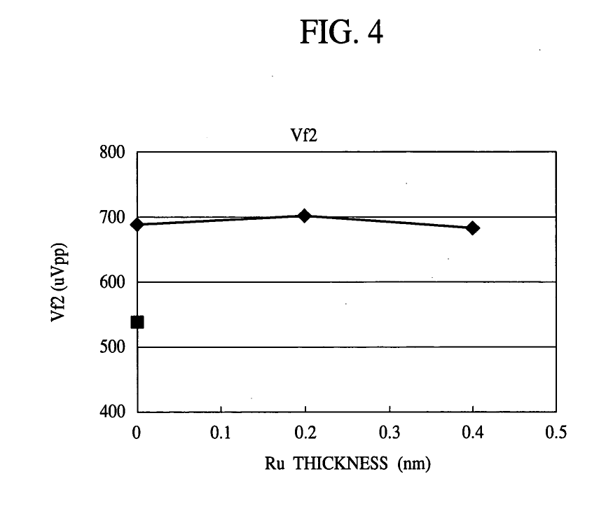

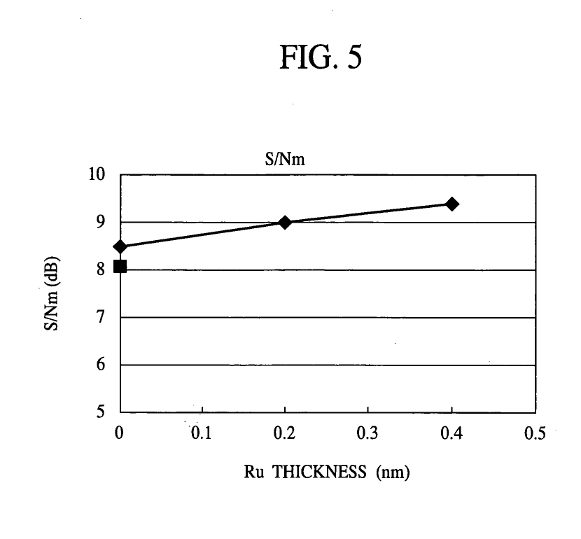

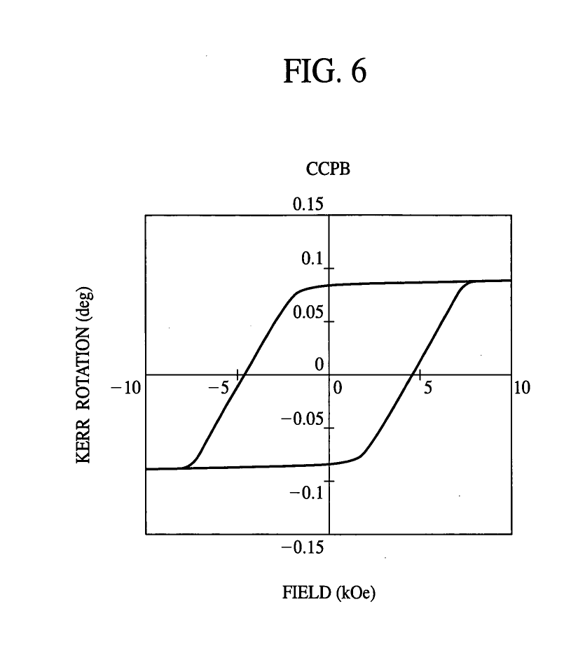

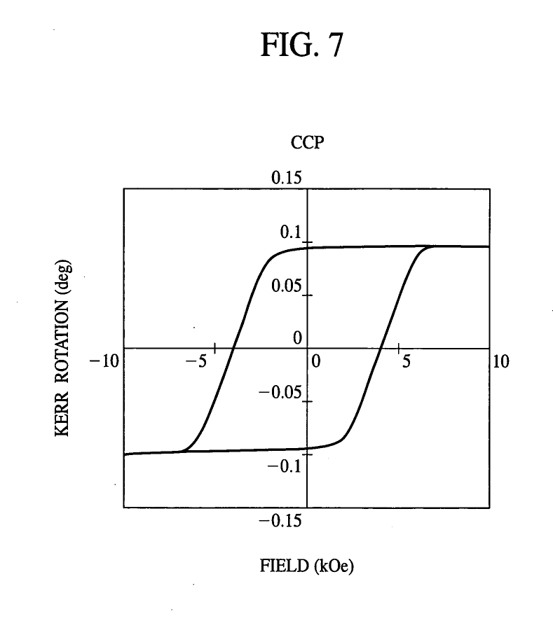

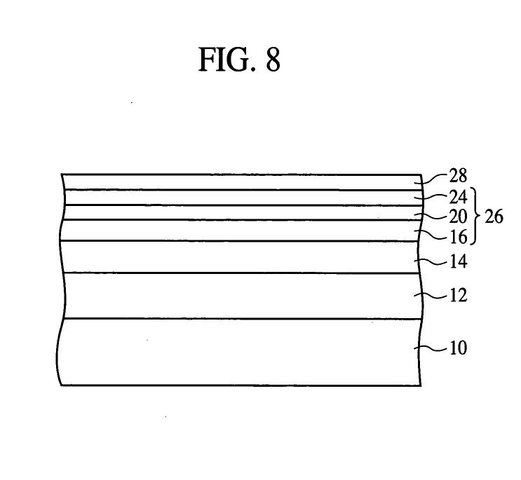

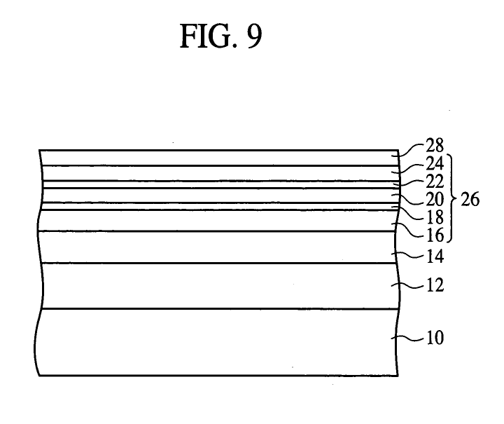

FIG. 1 is a diagrammatic sectional view showing a structure of the vertical magnetic recording medium according to the present embodiment. FIGS. 2A and 2B are views showing the relationship of the magnetization directions of the respective recording layers of the vertical magnetic recording medium. FIGS. 3 and 4 are graphs showing the relationship between the signal output from the vertical magnetic recording medium and the film thickness of the exchange coupling force control layer. FIG. 5 is a graph showing the relationship between the signal quality of the signal output from the vertical magnetic recording medium and film thickness of the exchange-coupling force control layer. FIGS. 6 and 7 are graphs of the MH loop characteristic of a third recording layer of the vertical magnetic recording medium according to the present embodiment. FIGS. 8 and 9 are diagrammatic sectional views showing structures of modifications of the vertical magnetic recording medium according to the present embodiment.

First, the structure of the vertical magnetic recording medium according to the present embodiment will be explained with reference to FIG. 1.

A backing layer 12 of a soft magnetic material is formed on a substrate 10. An intermediate layer 14 of a non-magnetic material is formed on the backing layer 12. A first recording layer 16 of a ferromagnetic material is formed on the intermediate layer 14. A second recording layer 20 of a ferromagnetic layer is formed on the first recording layer 16. An exchange coupling force control layer 22 is formed on the second recording layer 20. A third recording layer 24 of a ferromagnetic layer is formed on the exchange coupling force layer 22. A vertical magnetic recording layer 26 is thus formed of the first recording layer 16, the second recording layer 20, the exchange coupling force control layer 22 and the third recording layer 24. A protection layer 28 is formed on the vertical magnetic recording layer 26.

The substrate 10 is a glass substrate, an aluminum substrate or others and is formed of a material which is good in surface flatness and mechanical strength.

The backing layer 12 is for circulating a recording magnetic field generated from a recording head to form a closed flux path and is formed of a soft magnetic material, e.g., CoZrNb, CoZrTa, FeCoB, FeTaC, FeTaN, FeAlSi, FeCoAlO, CoNiFeB, CoFe₂O₄, ZnFe₂O₄, CoFe or others.

The intermediate layer 14 is for controlling the crystal orientation of the vertical magnetic recording layer 26 and preventing the interaction between the backing layer 12 and the vertical magnetic recording layer 22, and is formed of a non-magnetic material, e.g., Ru, Cr, Rh, Ir, their alloys, or others. Such non-magnetic material is formed on a base layer of Ta or others, and the intermediate layer 14 generally has the structure of Ru/NiFe/Ta, Ru/Ta, Ru/NiFeCr/Ta or others.

The vertical magnetic recording layer 26 is for recording required magnetic information. The first recording layer 16 is a ferromagnetic layer having the easy magnetization axis vertical to the substrate formed of, e.g., CoCrPt—SiO₂, CoCrPtO, (Pt/Co)ₙ, (Fe/Pt)ₙ or others. The second recording layer 20 is a ferromagnetic layer having the easy magnetization axis which is in-plane or oblique to the substrate and is formed of, e.g., a Co alloy, such as Co, CoCr or others, or others. The third recording layer 24 is a ferromagnetic layer having the easy magnetization axis vertical to the substrate and is formed of, e.g., CoCrPtB, CoCrPt or others. The exchange coupling force control layer 22 is formed of a non-magnetic material, such as Ru, Cr, Rh, Ir, their alloys or others.

Ferromagnetic coupling is formed between the first recording layer 16 and the second recording layer 10 and between the second recording layer 20 and the third recording layer 24. The exchange coupling force between the second recording layer 20 and the third recording layer 24 is controlled by the thickness of the exchange coupling force control layer 22.

The protection layer 28 is for protecting the surface when the magnetic head scans the vertical magnetic recording medium, and is formed of, e.g., carbon film or others.

Here, the vertical magnetic recording medium according to the present embodiment is characterized mainly in that the vertical magnetic recording layer 26 includes the third recoding layer 24 formed on the second recording layer with the exchange coupling force control layer 22 formed therebetween. The vertical magnetic recording layer 26 of the vertical magnetic recording medium according to the present embodiment will be detailed with reference to FIGS. 2A to 7.

The first magnetic layer 16 is a magnetic layer which mainly plays the role of recording, and is formed of vertical magnetic film. The second recording layer 20 assists the magnetization inversion, and is an in-plane magnetization film or a magnetization film whose easy magnetization axis is oblique. The structure of the vertical magnetic recording including the first recording layer 16 and the second recording layer 20 is called the ECC (Exchange Coupled Composite) medium.

In such ECC medium, in which the easy magnetization axis of the second recording layer 20 is in-plane or oblique, when the first recording layer 16 and the second recording layer 20 are exchange-coupled with each other, the magnetization direction of the second recording layer 20 becomes a little vertical but does not become vertical at the upper part of the medium.

That is, the relationship of the magnetization direction between the first recording layer 16 and the second recording layer 20 is indicated by arrows as exemplified in FIG. 2A. In FIG. 2A, the magnetization direction of the second recording layer 20 forms an angle θ₁ to the normal direction of the substrate.

Upon the reproduction of the medium, magnetic field outputted from the medium is detected by the magnetic head. The direction of the lines of magnetic force outputted from the surface of the medium largely depends on the magnetization direction of the upper part of the medium. That is, as the magnetization direction of the upper part of the medium is more oblique to the normal direction of the substrate, the direction of the lines of magnetic force is more oblique. Accordingly, upon the reproduction of the disc, signal output loss is caused, and the signal quality is degraded. Furthermore, when the in-plane magnetization component remains, noises are caused, and the signal quality is more degraded.

In the vertical magnetic recording medium according to the present embodiment, however, the third recording layer 24, which is a vertical magnetization film, is provided on the second recording layer 20 with the exchange coupling force control layer 22 formed therebetween. The third recording layer 24 is singly a vertical magnetization film but has the easy magnetization axis tilted a little obliquely by exchange-coupling with the second recording layer 20. However, the magnetization direction of the third recording layer 24 is acute to the normal direction of the substrate in comparison with the easy magnetization axis of the second recording layer 20.

That is, the relationship of the magnetization directions of the first recording layer 16, the second recording layer 20 and the third recording layer 24 of the vertical magnetic recording medium according to the present embodiment is indicated by arrows as exemplified in FIG. 2B. In FIG. 2B, the magnetization direction of the third recording layer 24 forms an angle θ₂ to the normal direction of the substrate, which is smaller than the angle θ₁.

Accordingly, the magnetization direction of the upper part of the medium approaches the vertical direction, whereby the signal output loss is reduced, and the noise is decreased owing to the in-plane magnetization component decrease.

As shown in FIG. 2B, the second recording layer 20 has the easy magnetization axis directed in-plane or oblique even in the state where the second recording layer 20 and the third recording layer 24 are exchange-coupled, and functions as a layer assisting the magnetization inversion upon the recording, as in the usual ECC medium.

Accordingly, the vertical recording medium according to the present embodiment can have the good recording characteristics of the ECC medium and additionally can improve the signal quality upon the reproduction.

The third recording layer is preferably formed of a magnetic material whose magnetic anisotropy is lower than the first recording layer. When the magnetic anisotropy of the third recording layer is too high, the recording magnetic field is, undesirably much increased.

The third recording layer is not the so-called granular film having the grains of a magnetic material magnetically isolated by a non-magnetic material but is preferably a film having the grains of a magnetic material formed continuous. This is because the third recording layer is formed of a continuous film, whereby the interaction among the grains of the granular film can be enhanced. The magnetic characteristics of the first recording layer alone, which is the granular film, allow, due to the grain diameter fluctuation, the ΔHs to be larger and the Hn to become plus. The ΔHs increase increases the recording magnetic field, and the shift of the Hn to plus decreases the reproduction output and increases the side erase. On the other hand, with the continuous film formed over the granular film, the interaction among the grains is caused, and the ΔHs decrease and the Hs shift to minus are caused. Furthermore, the Hs itself is decreased, whereby the recording field can be decreased.

FIGS. 3 and 4 are graphs showing the relationship between the signal output and film thickness of the exchange coupling force control layer (Ru film thickness) FIG. 3 plots the signal outputs so called Vf8, and FIG. 4 plots the signal outputs so called Vf2. The Vf8 indicates the characteristics of the case that long mark is recorded, and the Vf2 indicates the characteristics of the case that short mark is recorded. In the respective graphs, the ♦ mark indicates the cases of the magnetic recording medium according to the present embodiment, and the ▪ mark indicates the cases of the usual ECC medium, which does not include the third recording layer.

As shown, in both Vf8 and Vf2, it is found that the presence of the third recoding layer increases the signal output. This is because the magnetization direction of the upper part of the medium approaches the normal direction of the substrate because of the third recording layer, and the vertical output component is increased. Small variations of the signal output are found depending on the film thickness of the exchange coupling force control layer, but the variations are very small.

FIG. 5 is a graph showing the relationship between the signal quality (S/Nm) and the film thickness of the exchange coupling force control layer (Ru film thickness) The signal quality is the so-called S/N ratio. The noise is increased as the horizontal magnetization component is larger, and the S/Nm is lowered. In the graph, the ♦ mark indicates the case of the magnetic recording medium according to the present embodiment, and the ▪ mark indicates the case of the usual ECC medium, which does not include the third recording layer.

As shown, it is found that the presence of the third recording layer improves the signal quality. This is because the magnetization direction of the upper part of the medium approaches the normal direction of the substrate because of the third recording layer, and the horizontal noise component is decreased. It is also found that as the film thickness of the exchange coupling force control layer is increased, the signal quality is improved. This is because the exchange coupling force between the second recording layer and the third recording layer is decreased by the increase of the film thickness of the exchange coupling force control layer, and the magnetization direction of the third recording layer is directed more vertically.

FIGS. 6 and 7 show the graphs of the MH loop characteristic of the third recording layer. FIG. 6 shows the case that the third recording layer is formed of CoCrPtB, and FIG. 7 shows the case that the third recording layer is formed of CoCrPt.

As shown, the saturation magnetization Hs of the case that the third recording layer is formed of CoCrPtB was about 7.8 kOe, and the saturation magnetization Hs of the case that the third recording layer is formed of CoCrPt was about 6.8 kOe.

The overwrite characteristic was measured. The overwrite characteristic of the case that the third recording layer is formed of CoCrPtB was about −39.5 dB, and the overwrite characteristic of the case that the third recording layer is formed of CoCrPt was about −46.7 dB.

Based on the above-described results, it is found that the third recording layer is formed more preferably of CoCrPt than CoCrPtB.

As described above, the continuous magnetic film is added to the granular single layer magnetic film, whereby the Hs is decreased to thereby decrease the recording magnetic field. The use of CoCrPt in place of CoCrPtB can lower the Hs without much changing the magnetic anisotropy of the magnetic film, i.e., the recording magnetic field can be decreased with the thermal fluctuation resistance being retained. This will be the reason why the CoCrPt can provide better characteristics than CoCrPtB.

Then, the method for fabricating the vertical magnetic recording medium according to the present embodiment will be explained with reference to FIG. 1.

First, a soft magnetic material, e.g., CoZrNb, CoZrTa, FeCoB, FeTaC, FeTaN, FeAlSi, FeCoAlO, CoNiFeB, CoFe₂O₄, ZnFe₂O₄, CoFe or others, of, e.g., of about 20 nm-thickness is deposited on the substrate, such as a glass substrate, an aluminum substrate or others by, e.g., sputtering method or plating method to form the backing layer 12.

Then, a non-magnetic material, e.g., Ru/NiFe/Ta, Ru/Ta, Ru/NiFeCr/Ta or others of, e.g., an about 25 nm-thickness is deposited on the backing layer 12 by, e.g., sputtering method to form the intermediate layer 14.

Next, a ferromagnetic material having the vertical anisotropy, e.g., CoCrPt—SiO₂, CoCrPtO, (Pt/Co)ₙ, (Fe/Pt)ₙ, or others of, e.g., an about 10 nm-thickness is formed on the intermediate layer 14 by, e.g., sputtering method to form the first recording layer 16.

Then, a ferromagnetic material having the easy magnetization axis directed in-plane or oblique, e.g., a Co alloy, such as Co, CoCr, or others, of, e.g., an about 1 nm-thickness is formed on the first recording layer 16 by, e.g., sputtering method to form the second recording layer 20.

Then, a non-magnetic material, e.g., Ru, Cr, Rh, Ir, their alloys, or others of, e.g., an about 0.2-0.6 nm-thickness is formed on the second recording layer 20 by, e.g., sputtering method to form the exchange coupling force control layer 22.

Then, a ferromagnetic material having the vertical magnetic anisotropy, e.g., CoCrPtB, CoCrPt or others of, e.g., an about 5-6 nm-thickness is formed on the exchange coupling force control layer 22 by, e.g., sputtering method to form the third recording layer 24.

Thus, the vertical magnetic recording layer 26 of the first recording layer 16, the second recording layer 20, the exchange coupling force control layer 22 and the third recording layer 24 is formed.

Then, CN, DLC, SiN or others is deposited in, e.g., an about 3 nm-thickness on the vertical magnetic recording layer 26 to form the protection layer 28.

Then, a lubricant (not shown) is applied to the protection layer 28, and the vertical magnetic recording medium according to the present embodiment is completed.

As described above, according to the present embodiment, the vertical magnetic recording layer is formed of the first recording layer which is a vertical magnetization film, the second recording layer formed over the first recording layer and having the easy magnetization axis directed in-plane or oblique, and the third recording layer which is formed over the second recording layer and is a vertical magnetization film, whereby the magnetization direction of the upper part of the medium can approach the normal direction of the substrate. This can improve the reproduction output of the vertical magnetic recording medium, and the degradation of the signal quality due to the reproduction output decrease can be prevented.

In the above-described embodiment, the third recording layer 24 is formed over the second recording layer 20 with the exchange coupling force control layer 22 formed therebetween, but the exchange coupling force control layer 22 is not essential. That is, as exemplified in FIG. 8, it is possible to form the third recording layer 24 directly on the second recording layer 20, forming the vertical magnetic recording layer 26 of the first recording layer 16, the second recording layer 20 and the third recording layer 24. As shown in FIGS. 3, 4 and 5, the magnetic recording medium according to the present embodiment can more improve the reproduction output and the signal output even without the exchange coupling force control layer 22 than the usual ECC medium.

Preferably, whether or not the exchange-coupling force control layer 22 is provided, and the film thickness and the constituent material of the exchange coupling force control layer 22 are set suitably corresponding to the exchange coupling force required between the second recording layer 20 and the third recording layer 24.

In the present embodiment, the second recording layer 20 is formed directly on the first recording layer 16, but an exchange coupling force control layer is further provided between the first recording layer 16 and the second recording layer 20. That is, as exemplified in FIG. 9, it is possible that the exchange coupling force control layer 18 of a non-magnetic material is formed on the first recording layer 16, the second recording layer 20 is formed on the exchange coupling force control layer 18, an exchange coupling force control layer 22 is formed on the second recording layer 20, and the third recording layer 24 is formed on the exchange coupling force control layer 22. As in the magnetic recording medium shown in FIG. 8, the exchange coupling force control layer 18 may be formed between the first recording layer 16 and the second recording layer 20. The exchange coupling force control layer 18 can be formed of a non-magnetic material, e.g., Ru, Cr, Rh, Ir, their alloys or others.

In the ECC medium, between a recording layer of a vertical magnetization film and a recording layer having the easy magnetization axis directed in-plane or oblique, an exchange coupling force control layer for controlling the exchange coupling force between the recording layers is often provided. In the vertical magnetic recording medium according to the present invention as well, the exchange coupling force control layer 18 is provided between the first recording layer 16 and the second recording layer 20, whereby the exchange coupling force between the first recording layer 16 and the second recording layer 20 can be controlled, and the write characteristics can be optimized.

Preferably, whether or not the exchange coupling force control layer 18 is provided, and the film thickness and the constituent material of the exchange coupling force control layer 22 are set suitably corresponding to the exchange coupling force required between the first recording layer 16 and the second recording layer 20.

### A Second Embodiment

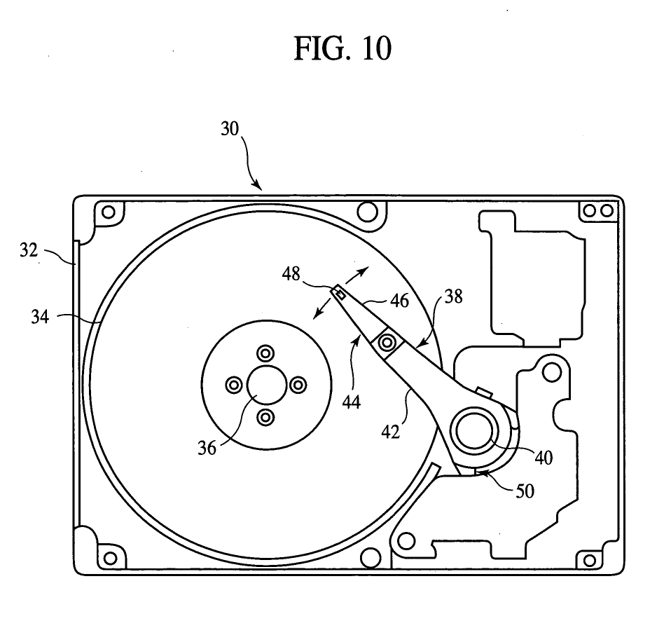

The magnetic recording device according to a second embodiment of the present invention will be explained with reference to FIG. 10.

FIG. 10 is a diagrammatic view of the magnetic recording device according to the present embodiment.

In the present embodiment, the magnetic recording device using the vertical magnetic recording medium according to the first or the second embodiment will be explained.

The magnetic recording device 30 according to the present embodiment includes a box-shaped casing body 32 defining an interior space of, e.g., a horizontally lengthy rectangle. The interior space accommodates one or more magnetic discs as the recording medium. The magnetic disc 34 is the vertical magnetic recording medium according to the first embodiment shown in FIG. 1 or the vertical magnetic recording medium according to the modifications of the first embodiment shown in FIGS. 8 and 9. The magnetic disc 34 is mounted on the rotary shaft of a spindle motor 36. The spindle motor 36 can turn the magnetic disc 34 at high speed of, e.g., 7200 rpm and 10000 rpm. A lid body, i.e., a cover (not shown) for tightly closing the accommodation space in cooperation with the casing body 32 is connected to the casing body 32.

Furthermore, a head actuator 38 is housed in the accommodation space. The head actuator 38 is rotatably connected to a vertically extended support shaft 40. The head actuator 38 includes a plurality of actuator arms 42 extended horizontally from the support shaft 40, and head suspension assemblies 44 extended forward from the actuator arms 42 mounted on the forward ends of the actuator arms 42. The actuator arms 42 are provided respectively for the front surface and the back surface of the magnetic discs 34.

Each head suspension assembly 44 has a loadbeam 46. The loadbeam 46 has the so-called resiliently flexible area connected to the forward end of the associated actuator arm 42. The resiliently flexible area acts to exert to the forward end of the loadbeam 46 a prescribed urging force directed to the front surface of the magnetic disc 34. A magnetic head 48 is mounted on the forward end of the loadbeam 46. The magnetic head 48 is received by a gimbal (not shown) freely to change the posture, which is fixed to the loadbeam 46.

When air currents are generated on the surface of the magnetic disc 34 by the rotation of the magnetic disc 34, a positive pressure, i.e., buoyancy, and a negative force are exerted to the magnetic head 48 by the air currents. The buoyancy and the negative pressure, and the urging force of the loadbeam 46 balance each other, whereby the magnetic head 48 can be set on floating with relatively high rigidity during the rotation of the magnetic disc 34.

The actuator arm 42 is connected to a driving force source 50, e.g., a voice coil motor (VCM). The driving force source 50 turns the actuator arm 42 around the support shaft 40. The actuator arm 42 is thus turned to move the head suspension assemblies 44. When the actuator arm 42 swings around the support shaft 40 while the magnetic head 48 is floating, the magnetic head 48 can traverse radially the surface of the magnetic disc 34. Such motion positions the magnetic head at a required recording track on the magnetic disc 34.

As described above, the magnetic recording device uses the vertical magnetic recording medium according to the first embodiment, whereby the reproduction output and S/N ratio of the vertical magnetic recording medium can be improved. Thus, the characteristics and the reliability of the magnetic recording device can be improved.

### Modified Embodiments

The present invention is not limited to the above-described embodiments and can cover other various modifications.

For example, the constituent materials of the vertical magnetic recording medium according to the above-described embodiment are typical materials and are not limited to these materials and their combinations. The constituent materials and their combinations can be suitably changed corresponding to characteristics etc. required of the vertical magnetic recording medium.

Furthermore, more layers may be added to the vertical magnetic recording layer in a range where the effect of the present invention can be produced. For example, the exchange coupling force control layers 18, 22 may have not only the single-layer structure, but also have a two-layer structure of, e.g., a ferromagnetic layer/a non-magnetic layer or a non-magnetic layer/a ferromagnetic layer, or a three-layer structure of, e.g., a ferromagnetic layer/a non-magnetic layer/a ferromagnetic layer.

What is claimed is:

1. A vertical magnetic recording medium comprising:
a first recording layer formed over a substrate and having an easy magnetization axis directed vertical to a surface of the substrate;
a second recording layer formed over the first recording layer and having an easy magnetization axis directed in-plane of the substrate or oblique to the surface of the substrate; and
a third recording layer formed over the second recording layer and having an easy magnetization axis directed vertical to the surface of the substrate.

2. The vertical magnetic recording medium according to claim 1, wherein
an angle formed by a magnetization direction of the third recording layer and a normal direction of the substrate is smaller than an angle formed by a magnetization direction of the second recording layer and the normal direction of the substrate.

3. The vertical magnetization recording medium according to claim 1, further comprising:
a first exchange coupling force control layer formed between the first recording layer and the second recording layer for controlling an exchange coupling force between the first recording layer and the second recording layer.

4. The vertical magnetic recording medium according to claim 1, further comprising:
an exchange coupling force control layer formed between the second recording layer and the third recording layer for controlling an exchange coupling force between the second recording layer and the third recording layer.

5. The vertical magnetic recording medium according to claim 3, further comprising:
a second exchange coupling force control layer formed between the second recording layer and the third recording layer for controlling an exchange coupling force between the second recording layer and the third recording layer.

6. The vertical magnetic recording medium according to claim 1, wherein
the third recording layer has less magnetic anisotropy than the first recording layer.

7. The vertical magnetic recording medium according to claim 1, wherein
the first recording layer is formed of a film having crystal grains of a magnetic material magnetically isolated by a non-magnetic material, and
the third recording layer is formed of a film having a magnetic material continuously formed.

8. The vertical magnetic recording medium according to claim 1, wherein
the third recording layer is formed of CoCrPt or CoCrPtB.

9. The vertical magnetic recording medium according to claim 3, wherein
the first exchange coupling force control layer is formed of Ru, Cr, Rh, Ir or their alloys.

10. The vertical magnetic recording medium according to claim 4, wherein
the exchange coupling force control layer is formed of Ru, Cr, Rh, Ir or their alloys.

11. The vertical magnetic recording medium according to claim 5, wherein
the second exchange coupling force control layer is formed of Ru, Cr, Rh, Ir or their alloys.

12. A magnetic recording device comprising:
a vertical magnetic recording medium including a first recording layer formed over a substrate and having an easy magnetization axis directed vertical to a surface of the substrate, a second recording layer formed over the first recording layer and having an easy magnetization axis directed in-plane of the substrate or oblique to the surface of the substrate, and a third recording layer formed over the second recording layer and having an easy magnetization axis directed vertical to the surface of the substrate; and
a magnetic head disposed near the vertical magnetic recording medium, for recording magnetic information in a prescribed recording region of the vertical magnetic recording medium and reading magnetic information in a prescribed recording region of the vertical magnetic recording medium.
